(19) United States
(12) Patent Application Publication
(10) Pub. No.: US 2019/0375369 A1
(43) Pub. Date: Dec. 12, 2019

(54) LIGHT WEIGHT HINGE

(71) Applicant: MAGNA BOCO GMBH, Wuppertal (DE)

(72) Inventors: Michael HUFEN, Wuppertal (DE); Alexander TRIEBENECK, Solingen (DE); Stefan PAGE, Wuppertal (DE)

(21) Appl. No.: 16/436,980

(22) Filed: Jun. 11, 2019

Related U.S. Application Data
(60) Provisional application No. 62/683,818, filed on Jun. 12, 2018.

(51) Int. Cl. B60R 21/38; E05D 3/06

(52) U.S. Cl. CPC B60R 21/38; B60R 2021/0004; E05D 3/06

(57) ABSTRACT

A hinge for a hood assembly of the type used in a motor vehicles. The hinge includes at least one structural composite component, attached to one of the hood and the body of a vehicle, and configured to include a plastic portion overmolded into a core panel.

### CROSS-REFERENCE TO RELATED APPLICATIONS

This application claims priority to U.S. Provisional Application No. 62/683,818 filed Jun. 12, 2018 and entitled “Light Weight Hinge”, which is incorporated herein by reference in its entirety.

### FIELD

The present disclosure relates generally to hinges of the type used in motor vehicles to support a closure member for movement between open and closed positions. In particularly, the present disclosure is directed to a hinge assembly constructed of at least one composite hinge component and configured for use with a vehicle hood.

### BACKGROUND

This section provides background information related to the present disclosure which is not necessarily prior art.

In recent years, a great deal of emphasis has been directed to development of pedestrian protection systems for use in motor vehicles in an effort to reduce the likelihood or severity of injuries caused during a collision between a pedestrian and a motor vehicle. One such area of development has been directed to equipping the motor vehicle with a hood assembly capable of absorbing impact forces.

A “passive” pedestrian protection system associated with the hood assembly includes a pocket of under-hood crush space provided between the hood and the components within the vehicle's engine compartment. This crush space is configured to reduce the chance of bodily impact with the components within the engine component and, more particularly, to provide an impact absorbing feature. However, the use of low profile hoods in modern motor vehicles for improved aesthetics and aerodynamics, in combination with smaller engine compartments, limits the available crush space.

As an alternative, an “active” pedestrian protection system associated with the vehicle's hood assembly provides a “deployable” hood that is configured to raise a rear portion of the latched hood to create the additional under-hood crush space. This deployable hood feature is activated in response to detection of a pedestrian collision with the front end of the motor vehicle. Typically, a pair of active hinges are incorporated into the hood assembly. Each active hinge includes a pivot linkage interconnecting the hood to the vehicle body and an actuator that is operable to forcibly move the pivot linkage for causing the hood to move from a non-deployed position to a deployed position in response to detection of the pedestrian impact. Examples of active hinges that provide this functionality are disclosed in commonly-owned U.S. Pat. No. 8,544,590 and U.S. Publication No. 2014/0182962. One drawback associated with active hood hinges formed from metal is that the active pedestrian protection system must not only overcome the mass of the hood, but also the mass of the metal hinge components to deploy the hood to an active pedestrian position. To this end, a need exists to reduce the weight of the hinge for improving active pedestrian protection system deployment times, and the reduction in the output power and size of the actuator of the active pedestrian protection system, while providing an active hinge that can resist the rapid deployment forces imparted by the actuator on the hinge during an active pedestrian protection operation. In some active hinges, the actuator is used to hold the hood in its deployed position. For example, some active hinges use a pyrotechnic actuator which typically requires controlled venting to maintain the upward force that is applied to the pivot linkage. To this end, a need exists to provide alternative solutions for locating and retaining the hood in its deployed position which address and overcome shortcomings of conventional active hinges.

Additionally, it is desirable to provide hinges, such as hood hinges for a motor vehicle for example, which are lightweight and maintain the desired strength and stiffness characteristics matching or exceeded those of metal hinges. One known lightweight material alternative to metal employed in hinges is carbon fiber. However, some drawbacks associated with employing carbon fiber material with hinges include an increased manufacturing complexity and an increase in material costs compared to hinges formed using metal.

In recent years, attention has also been directed to development of lower weight components for use in structural portions of motor vehicles. To this end, a need exists to provide alternative solutions for vehicle hood hinge assemblies, both passive and active, that address and overcome the shortcomings of conventional stamped steel hinge components.

### SUMMARY

This section provides a general summary of the disclosure and is not intended to be interpreted as a comprehensive listing of its full scope or all of its objects, aspects features and/or advantages.

In accordance with one aspect there is provided a hinge including a hood bracket for attachment to a vehicle hood, and a body bracket for attachment to a vehicle body, where at least one of the body bracket and hood bracket is a composite component having a plastic body portion. In accordance with a related aspect, the hinge further includes, a deploy bracket pivotably attached to the hood bracket and the body bracket, the hood bracket being pivotable relative to the deploy bracket between a non-deployed position and a deployed position, a latch mechanism having a primary latch operable for releaseably latching the hood bracket to the deploy bracket in the non-deployed position and a secondary latch operable for releaseably latching the hood bracket to the deploy bracket in the deployed position, and an actuator for releasing the primary latch and permitting movement of the hood bracket to its deployed position. In accordance with a related aspect, the deploy bracket is pivotably coupled to the body bracket via a pivot linkage mechanism having at least one composite link lever. In accordance with a related aspect, the body bracket includes a metal core panel and a plastic portion secured to the core panel. In accordance with a related aspect, the plastic portion is overmolded onto the metal core panel. In accordance with a related aspect, the hood bracket includes a plastic main body supporting at least one metal support sleeve. In accordance with a related aspect, the plastic main body is overmolded over the metal support sleeve. In accordance with a related aspect, at least one of the body bracket and the hood bracket is comprised of a composite core panel overmolded with a fiber reinforced plastic. In accordance with a related aspect, at least one of the body bracket and the hood bracket is of a plastic material and includes a face presenting an array of honeycombed cells for providing strength and stiffness to the at least one of the body bracket and the hood bracket. In accordance with another related aspect, at least a pair of metal support sleeves are press-fitted or overmolded into the at least one of the body bracket and the hood bracket. In accordance with another related aspect, a series of reinforcement ribs of a plastic material extend radially from the metal support sleeves. In accordance with a related aspect, the body bracket is of a plastic material and defines a pair of integrated bush bores, and wherein the body bracket further defines a plurality of reinforcement ribs that extend radially from the integrated bush bores. In accordance with a related aspect, the hood bracket is a composite component with a plastic body portion, and wherein a pair of tubular inserts are overmolded into the body portion for receiving a fastener to secure the hood bracket to a hood of the vehicle.

In accordance with another aspect of the present disclosure, there is provided a hinge including a hood bracket for attachment to a vehicle hood, a body bracket for attachment to a vehicle body, a link coupled with at least one of the hood bracket and the body bracket, the link including a housing defining a chamber and a body part retained in the chamber, and the housing defining at least one housing channel for receiving a fastener for coupling the link with at least one of the hood bracket and the body bracket of the hinge, where the housing is of a metal material and the body part is of a plastic material. In accordance with a related aspect, the body part includes a plurality of reinforcement ribs defining an array of hexagonal cavities. In accordance with another related aspect the housing has a base being planar and a sidewall extending transversely from the base. In accordance with yet another related aspect, the sidewall of the housing defines a plurality of openings, and wherein the body part includes a plurality of tabs received by and coupled with the openings for securing the body part to the housing. In accordance with still another related aspect, the body part defines a mounting bearing received by the housing channel and defining a bearing channel for receiving the fastener for coupling the link with at least one of the hood bracket and the body bracket of the hinge.

In accordance with yet another aspect, there is provided a hinge including a hood bracket for attachment to a vehicle hood, a body bracket for attachment to a vehicle body, a link coupled with at least one of the hood bracket and the body bracket, the link including a core plate and an outer body part encapsulating the core plate, and a pair of bearing channels defined by the outer body part in spaced relationship with one another for receiving a fastener for coupling the link with at least one of the hood and body brackets where the core plate is of a metal material and the outer body part is of a plastic material. According to a related aspect, the core plate includes a main section that extends between the pair of bearing channels and wherein the main section terminates at a pair of end sections each wrapped about one of the bearing channels.

In accordance with one other aspect of the present disclosure, there is provided a composite hinge and composite hinge components for a vehicle.

In accordance with a further aspect of the present disclosure there is provided a composite hinge component for a vehicle hood hinge assembly, the composite hinge component having a plastic body supporting metal sleeves for receiving fasteners, the metal sleeves for supporting the compressive load imparted by the fasteners to prevent the compressive loading from acting on the plastic body and causing deformation and/or fatigue of the plastic body.

In accordance with another aspect of the present disclosure, there is provided a composite hinge component for a vehicle hood hinge assembly, the composite hinge component having a plastic body having an array of reinforcing cells defining the plastic body.

Another aspect of the present disclosure provides a composite hinge component for a vehicle hood hinge assembly, the composite hinge component having a plastic body having at least two subarrays of reinforcing cells defining the plastic body, at least one of the two subarrays provided to surround an aperture for receiving a fastener. In accordance with a related aspect, the subarray surrounding the aperture has a higher strength than the other subarrays.

In accordance with a further aspect of the present disclosure there is provided a composite hinge component for a vehicle hood hinge assembly, the composite hinge component having a planar core having apertures formed therein for providing in plane strength between the apertures, and a connected plastic body portion extending out of plane from the planer core for providing out of plane stiffness to the composite hinge component.

In accordance with a further aspect of the present disclosure there is provided a composite hinge component for a vehicle hood hinge assembly, the composite hinge component having a planar structure having apertures formed therein for providing in plane strength between the apertures, and a series of discrete structures, such as reinforcing ribs as an example, extending out of plane from the planer core with varying densities for providing out of plane stiffness to the composite hinge component. In accordance with a related aspect, the density of the discrete structures is maximal in a volume surrounding the aperture.

According to another aspect of the disclosure, a hood bracket for a hood hinge is provided for attachment to a vehicle hood and to a body bracket for attachment to a vehicle body, the hood bracket is a composite component having a plastic body portion.

According to another aspect of the disclosure, a body bracket for a hood hinge is provided for attachment to a vehicle body and to a hood bracket for attachment to a vehicle hood, the body bracket is a composite component having a plastic body portion.

According to another aspect of the disclosure, a component for a hood hinge is provided, the component including a first array structure provided to surround an aperture formed in the component for receiving a fastener to secure the component to one of a hood of the vehicle and a body of the vehicle and a link coupled with at least one of the hood bracket and the body bracket, and a second array structure provided to connected with at least a portion of the first array structure.

In accordance with another aspect, there is provided a method of manufacturing a component for a hinge including the steps of forming at least one first structure having a first strength, and configured to each bound at least one aperture for receiving a fastener to secure the component to one of a vehicle hood, a vehicle body and another hinge component, and forming a second structure having a second strength lower than the first strength and configured to interconnect with at least a portion of the first structure.

In accordance with another aspect, there is further provided a method of manufacturing a component for a hinge for coupling a hood to a body of a vehicle including the steps of forming a body having at least one first array structure configured to each bound an aperture for receiving a fastener to secure the component to one of the hood, the body and another component for a hinge, and forming a second array structure configured to interconnect the first array structures, and forming a planar structure interconnecting the first array structure with the second array structure.

In accordance with another aspect, there is further provided a method of manufacturing a component for a hinge for coupling a hood to a body of a vehicle, including the steps of stamping a planar core body having at least two apertures each for receiving a fastener to secure the component to one of the hood, the body and another component for a hinge, and connecting a plastic body to the planar core body having at least one first array structure configured to each bound an aperture for receiving a fastener to secure the component to one of the hood, the body and another component for a hinge, and a second array structure configured to interconnect the first array structure.

In accordance with another aspect, there is provided a hinge including a hood bracket for attachment to a vehicle hood, and a body bracket for attachment to a vehicle body, where at least one of the body bracket and hood bracket is a composite component having a plastic body portion.

In accordance with yet another aspect, there is provided a component for a hinge for a motor vehicle, including a body portion having at least two apertures each for receiving a fastener, the body portion having a planar structure extending along a plane and an array structure coupled to the planar structure and extending in a direction away from the plane of the planar structure.

A further aspect of the present disclosure is to provide an active hinge for use in a vehicle hood assembly including a pivot linkage mechanism interconnecting the hood to the vehicle body and a latching mechanism having a primary latch for normally holding the pivot linkage mechanism in a first or “pre-deployed” state and a secondary latch for holding the pivot linkage mechanism in a second or “deployed” state.

It is a further aspect of the present disclosure to provide the active hinge with a method for resetting the latching mechanism after movement of the pivot linkage mechanism from its deployed state back into its pre-deployed state.

In accordance with another aspect, there is provided a composite hinge formed entirely of plastic, without non-plastic structure material.

It should be appreciated that the disclosed arrangements of hinges provide a weight reduction without a change of strength and/or provides increased strength and/or stiffness. It should be appreciated that the disclosed arrangements of hinges provide for a plastic hinge capable of avoiding deformation and fatigue caused by loading subjected to the plastic hinge by fasteners.

Further aspects and areas of applicability will become apparent from the description provided. The description and specific examples in this summary are intended for purposes of illustration only and are not intended to limit the scope of the present disclosure.

### DRAWINGS

The drawings described herein are for illustrative purposes only of selected embodiments and not all possible implementations thereof such that the drawings are not intended to limit the scope of the present disclosure.

FIG. 1 is a side elevational view of a vehicle hood assembly having a hood and an active hinge constructed in accordance with the present disclosure and showing the vehicle hood assembly located in a normal-closed position with the hood in a latched condition and the active hinge in a non-deployed condition;

FIG. 2 is a similar side elevational view now showing the vehicle hood assembly in a deployed position with the hood maintained in its latched condition and its rear edge segment raised and with the active hinge in a deployed condition;

FIG. 3 is another similar side elevational view now showing movement of the vehicle hood assembly to an unlatched position with the hood in a released condition and pivoted to an intermediate open position while the active hinge is maintained in its deployed condition;

FIG. 4 is yet another side elevational view showing of the vehicle hood assembly moved to a reset position with the hood pivoted further to a fully open position for shifting the active hinge from its deployed condition into its non-deployed condition;

FIG. 5 is a side elevational view showing the vehicle hood assembly returned to its normal-closed position following resetting of the active hinge into its non-deployed condition;

FIG. 6 is a side elevational view of the active hinge constructed according to a first embodiment of the present disclosure with a primary latch of a latching mechanism engaged for holding a pivot linkage mechanism in a retracted orientation to define the non-deployed condition shown in FIG. 1;

FIGS. 7 and 8 are front and back isometric views of the active hinge shown on FIG. 6 to better illustrate its structure and the interaction of the components;

FIG. 9 is a side elevational view of the active hinge, similar to FIG. 6, but now showing the primary latch of the latching mechanism in a released mode and a secondary latch of the latching mechanism in a latched mode for holding the pivot linkage mechanism in an extended orientation to define the deployed condition shown in FIG. 2;

FIG. 10 is another isometric view of the active hinge with both the primary and secondary latches of the latching mechanism in their released mode following unlatching of the hood to permit pivotal movement of the hood to the intermediate opened position shown in FIG. 3;

FIG. 11 is yet another isometric view of the active hinge corresponding to movement of the hood to the fully open position of FIG. 4 and illustrating re-engagement of the primary latch of the latching mechanism for resetting the active latch in its non-deployed condition;

FIGS. 12 and 13 are front and rear isometric views of an active hinge constructed in accordance with an alternative embodiment of the present disclosure and which is applicable for use with the vehicle hood assembly shown in FIGS. 1 through 5 in substitution for the active hinge shown in FIGS. 6 through 11;

FIG. 14 is an isometric view of yet another embodiment of an active hinge;

FIG. 15 is similar to FIG. 14 but with the long lever link removed for additional clarity;

FIG. 16 is an opposite isometric view of the active hinge shown in FIG. 14;

FIG. 17 is a side view of a composite hinge strap body component (or “body bracket”) for use with an active hinge;

FIGS. 18A and 18B are front and back isometric views of a sheet metal core member associated with the composite hinge strap body component shown in FIG. 17;

FIGS. 19A and 19B are front and back isometric views showing the sheet metal core member of FIGS. 18A and 18B, respectively, and a molded plastic portion of the composite hinge strap component;

FIG. 20 illustrates the composite hinge strap component of the active hinge now including fiber-reinforced inserts located for providing additional structural rigidity and strength;

FIGS. 21A and 21B are front and back isometric views of a hinge strap body component of the active hinge now configured as a thermoformed fiber composite panel overmolded with fiber-reinforced plastic in accordance with an alternative construction;

FIGS. 22A-22C are sectional views taken through portions of the hinge strap body component shown in FIGS. 19A and 19B for illustrating various integrated features;

FIG. 23 is a isometric view of another composite hinge strap body component with metal support structures secured within a honeycombed main body segment and web-like reinforcement ribs surrounding the metal support structures;

FIG. 23A is a isometric view of yet another composite hinge strap body component with metal support structures secured within a honeycombed main body segment and web-like reinforcement ribs surrounding the metal support structures;

FIGS. 24A and 24B are front and rear isometric views of an alternative version of the composite hinge strap body component shown in FIG. 23;

FIG. 25 is an isometric view of a composite hinge strap hood component (“hood bracket”) adapted for use with the active hinges;

FIGS. 26A and 26B are front and back isometric views of a composite lever link component adapted for use with the active hinges;

FIG. 27A is a view of another composite lever link component and FIGS. 27B and 27C are partial sectional views taken through A-A and B-B, respectively, of FIG. 27A showing an injected plastic portion secured to a U-shaped metal panel via an injection molding process;

FIG. 28A is a view of yet another version of a composite lever link component with FIGS. 28B and 28C being partial sectional views taken through C-C and D-D, respectively, of FIG. 28A showing an over-molded portion and an encapsulated metal panel;

FIGS. 29-35 are isometric views of a composite active hinge assembly installed in a motor vehicle between the hood assembly and a structural body portion; and

FIG. 36 is a cross-sectional view take along the line A′-A′ of FIG. 29, illustrating the compressive load of the fastener acting on the body bracket;

FIGS. 37 to 39 are flowcharts illustrating methods of forming a hinge, in accordance with illustrative embodiments; and

FIG. 40 is a perspective view, partially cut away, of a front end of a motor vehicle showing a hood latch secured thereto via a pair of hinges and a hood in an open position.

Corresponding reference numerals indicate corresponding parts throughout the several views of the drawings.

### DETAILED DESCRIPTION

Example embodiments will now be described more fully with reference to the accompanying drawings.

Example embodiments of a vehicle hood assembly having a hood and at least one hinge, and illustratively an active hinge embodying the teachings of the present disclosure, will now be described more fully with reference to the accompanying drawings. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that the example embodiments may be embodied in many different forms and that neither should be construed to limit the scope of the disclosure. In some example embodiments, well-known processes, well-known device structures, and well-known technologies are not described in detail.

As will be detailed, the hinges and hinge components of the present disclosure may be used as part of a hood assembly for a pedestrian protection system on motor vehicles. More specifically, active hinges of the type disclosed herein are used for mounting a vehicle hood to a vehicle body in an effort to introduce an additional degree of freedom in the movement of the vehicle's hood when a pedestrian is struck by the vehicle to reduce the severity of injuries sustained when the pedestrian contacts the vehicle's hood. The hinges and hinge components of the present disclosure may be used as part of a conventional hood assembly without a pedestrian protection system on motor vehicles. The hinges of the present disclosure may also be used for other types of closure panels for a motor vehicle, such as for example and without limitation, a frunk, a trunk, a side door, a glove compartment or other storage compartment panel, and the like.

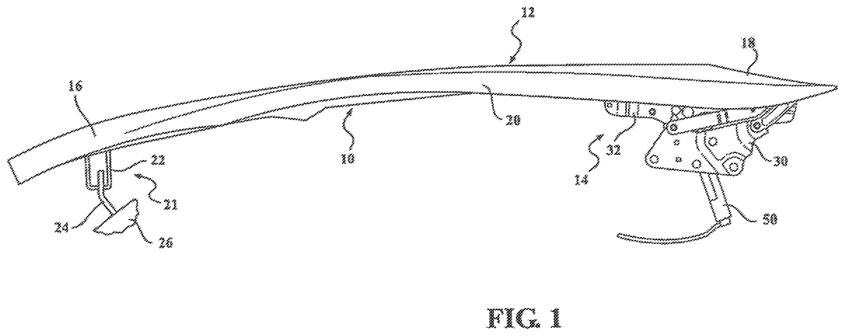

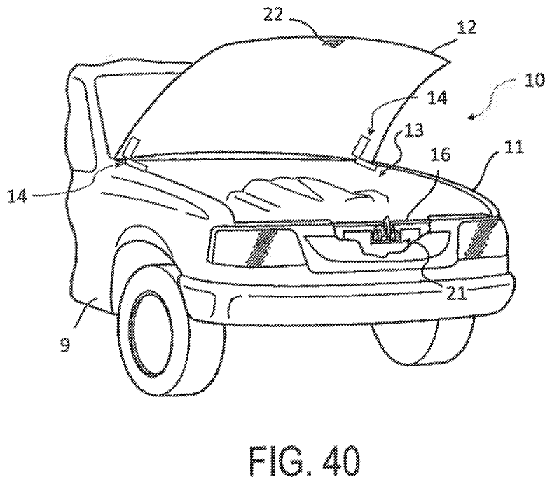

FIG. 1 illustrates a side elevational view of a vehicle hood assembly 10 for a motor vehicle 9 as shown in FIG. 40 generally configured to include a hood 12 and at least one hinge 14, such as an active or a passive hinge 14. The term “vehicle” is intended to broadly encompass any car, truck, SUV, van or any other type of passenger carrying vehicle. Hood assembly 10 is configured to overlie a compartment 13 of the vehicle 9, such as an engine compartment or a storage compartment without an engine also known as a “frunk” (a portmanteau word formed from blending the words “front trunk”), as defined by the vehicle's body 11. Hood 12 is shown to include a front segment 16, a rear segment 18 and a pair of laterally-spaced side segments 20. As is conventional, front segment 16 of hood 12 is configured to be located proximate to a front portion of the vehicle while rear segment 18 of hood 12 is configured to be located proximate to the vehicle's windshield.

In accordance with one example embodiment, and with further reference to FIG. 40, a pair of hinges 14, which may be active or passive hinges, are associated with hood assembly 10, each being located adjacent to one of side segments 20 of hood 12 and being configured to allow hood 12 to pivot between an open position with front segment 16 elevated to provide access to compartment 13, such as a stowage or engine compartment, and a normal-closed position whereat hood 12 is lowered to provide an unobstructed view for the person operating the vehicle 9. FIG. 1 illustrates an active hinge 14 positioned such that hood 12 pivots in proximity to its rear segment 18. The vehicle 9 is also equipped with a hood latching device 21 shown to include a striker 22 fixed to an underside portion of front segment 16 of hood 12 and a latch 24 mounted to a structural portion 26 of the vehicle's body 11. In particular, FIG. 1 illustrates striker 22 engaged and held by latch 24 so as to locate hood assembly 10 in its normal-closed position with active hinge 14 maintained in a “non-deployed” condition, whereby front segment 16 of hood is latched and rear segment 18 of hood 12 is located in its conventional lowered position.

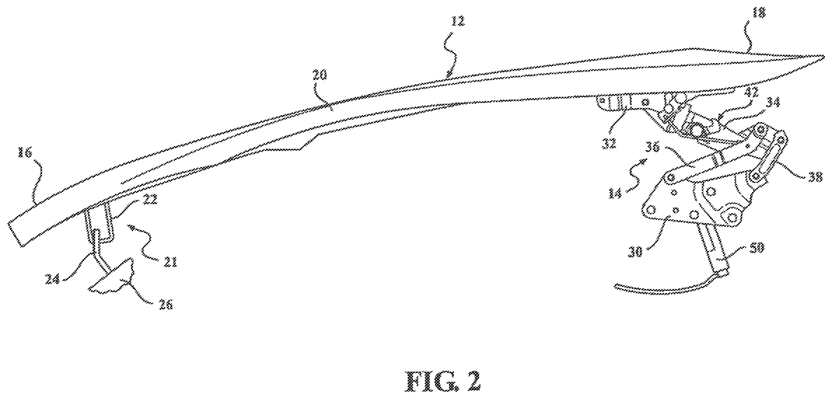

As will be detailed, active hinge 14 includes a pedestrian protection device that functions automatically in the event of a vehicle impact with a pedestrian. Specifically, the pedestrian protection device functions to shift active hinge 14 from its non-deployed state into a “deployed” condition, as shown in FIG. 2, where rear segment 18 of hood 12 is moved to a raised or deployed position while front segment 16 of hood 12 remains latched via latching device 21. Thus, active hinge 14 provides an additional degree of freedom in its movement to permit rear segment 18 of hood 12 to move from its normal lowered position (FIG. 1) into its raised position (FIG. 2). As will also be detailed, under normal (i.e., pre-collision) situations, this additional degree of freedom is disabled by a primary latch of a latching mechanism associated with active hinge 14 which, in turn, permits normal usage of hood 12, either by a manual movement by a user or a powered movement by a powered actuator (not shown) as examples. Normal usage is understood to mean pivotal movement of hood 12 between its normally-closed position of FIG. 1 and a normally-opened position (not shown) with active hinge 14 maintained in its non-deployed state. Release of the primary latch (via an actuator) functions to initiate shifting of active hinge 14 from its non-deployed state to its deployed state. It is recognized that the teachings herein may be applied to other types of hinges, for example a passive hinge, which is in other words a hinge not provided with a pedestrian protection device functioning to automatically deploy the hinge in the event of a vehicle impact with a pedestrian. A passive type hinge may be manually operated, for example by a user moving the hood 12 manually, or powered for example by a powered actuator moving the hood 12.

Active hinge 14 is configured to allow this additional degree of freedom in the movement of hood 12 in response to a vehicle/pedestrian collision, but without active hinge 14 deforming or absorbing energy during the collision. In addition, active hinge 14 provides a means for mechanically maintaining its deployed condition via a secondary latch 46 of the latching mechanism upon hood 12 being unlatched following the collision event. Furthermore, a reset function is provided by which the secondary latch is released and the primary latch is engaged so as to return active hinge 14 to its non-deployed condition.

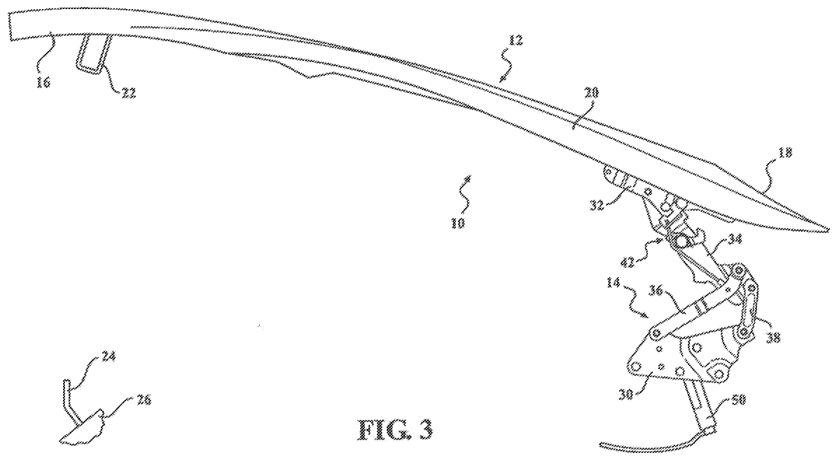

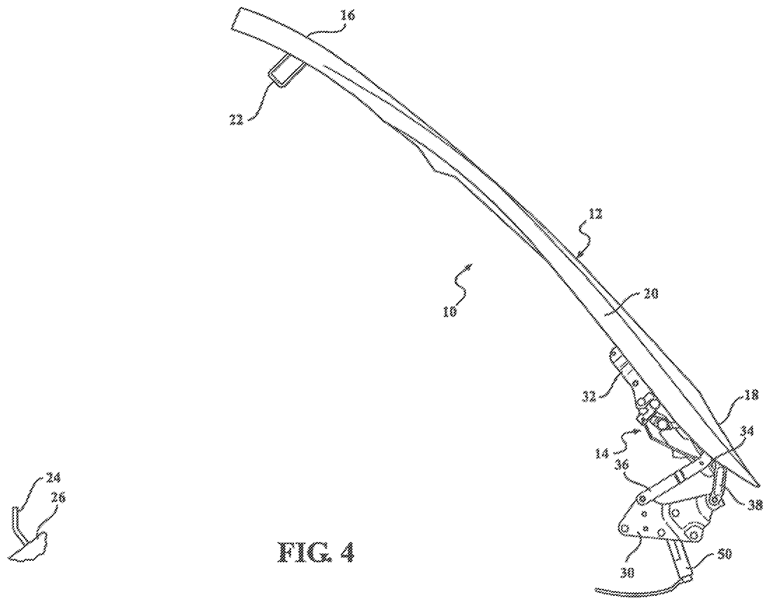

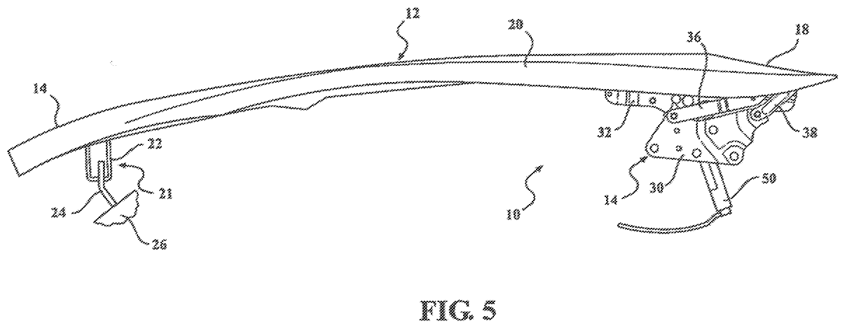

FIG. 3 illustrates hood assembly 10 in an unlatched position with hood 12 released from latch device 21 and pivoted toward an open position as active hinge 14 is maintained in its deployed condition. FIG. 4 illustrates continued pivotal movement of hood assembly 10 into a reset position with hood 12 now shown pivoted into in a fully opened position whereat the primary latch of the latching mechanism has been re-engaged so as to shift active hinge 14 back into its non-deployed state. As such, subsequent pivotal movement of hood assembly 10 in a closing direction into its normal-closed position will permit hood 12 to be moved into latched engagement with latch device 21, as shown in FIGS. 1 and 5.

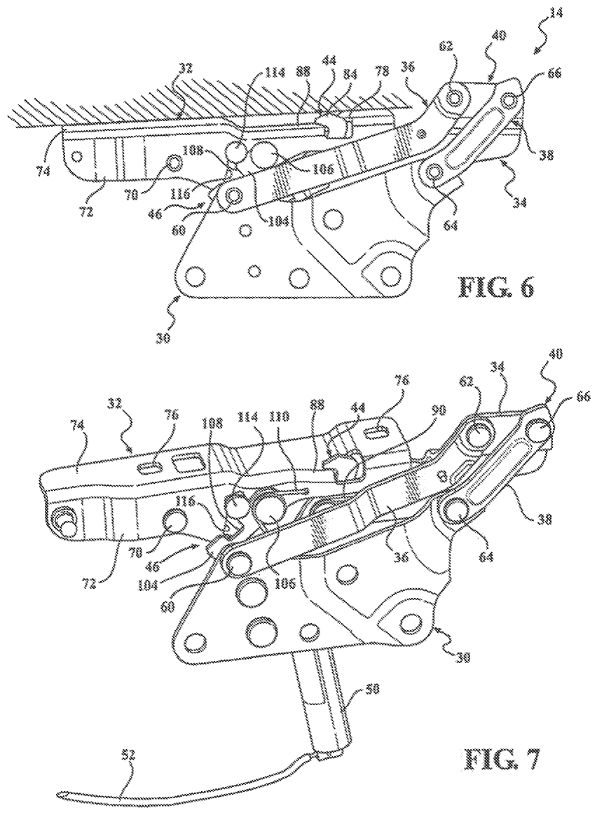

Referring now to FIGS. 6 through 8, a first example embodiment of active hinge 14 will now be described in sufficient detail to permit those skilled in the art to recognize and appreciate the structural and functional features provided by the present disclosure. Active hinge 14 is shown to generally include a body bracket 30, a hood bracket 32, a deploy bracket 34, and a pivot linkage mechanism 40 interconnecting between body bracket 30 and deploy bracket 34. The pivot linkage mechanism 40 has a first long link 36 and a second short link 38 arranged to define a four-bar linkage 40. Active hinge 14 further includes a latching mechanism 42 operably disposed between deploy bracket 34 and hood bracket 32 and having a primary latch 44 and a secondary latch 46. Deploy bracket 34 may be coupled to hood bracket 32 and to body bracket 30 using fasteners 15c, such as pivot pin 70 and pivot connection 120 for example. Such fasteners 15c allow for a pivotal coupling between the deploy bracket 34 and to the hood bracket 32 and the body bracket 30 when the fastener is received within an aperture formed in the deploy bracket, the hood bracket 32, and the body bracket 30. Hood bracket 32 may alternatively be coupled directly to hood bracket 32 via fasteners 15c in accordance with another embodiment. Hood bracket 32 is configured to be rigidly secured to an underside portion of rear segment 18 of hood 12 via suitable fasteners exemplified by fastener(s) 15a while body bracket 30 is configured to be rigidly secured to a portion of the vehicle's body 11 within the engine compartment by suitable fasteners exemplified by fastener(s) 15b. Finally, active hinge 14 includes an actuator 50 operable to selectively release primary latch 44 in response to a control signal being provided by a controller associated with an active passenger protection control system in response to one or more vehicle-mounted sensors or other detection devices detecting the occurrence of a pedestrian collision. In the example shown, actuator 50 includes an electrical connector 52 that would be in electrical connection with the sensor and/or the controller such that an electrical control signal is generated to control actuation of actuator 50. Actuator 50 may alternatively act directly on the hood 12, or hood bracket 32 or other hinge component for moving the hood 12 when the actuator is activated or deployed in an active pedestrian safety operation.

Pivot linkage mechanism 40 is shown with first link 36 having one end pivotably connected to body bracket 30 via a first pivot pin 60 and its opposite end pivotably connected to deploy bracket 34 via a second pivot pin 62,. Similarly, second link 38 is shown having a first end pivotably connected to body bracket 30 via a first pivot pin 64 and its second end pivotably connected to deploy bracket 34 via a second pivot pin 66. A pivot pin 70 pivotably connects a terminal end segment of deploy bracket 34 to a wall segment 72 of hood bracket 32. A flanged wall segment 74 of hood bracket 32 includes a series of mounting apertures 76 for attachment via fasteners to hood 12 and a primary latch slot 78. Pivot pins 60, 62, 64, are examples of a fastener 15c.

Primary latch 44 includes a primary latch plate 80 pivotably mounted to deploy bracket 34 via a primary latch pivot pin 82. Primary latch plate 80 includes a capture flange 84 and an actuation flange 86. As shown in FIGS. 6 through 8, capture flange 84 is configured to extend through primary latch slot 78 in hood bracket 32 and normally engage a latch surface 88 on flange segment 74 for latching hood bracket 32 to deploy bracket 34. A primary latch biasing spring 90 is provided for normally biasing primary latch plate 80 in a latching direction (i.e., counterclockwise in FIGS. 6 and 7) so as to normally engage capture flange 84 with latch surface 88 on flange segment 74.

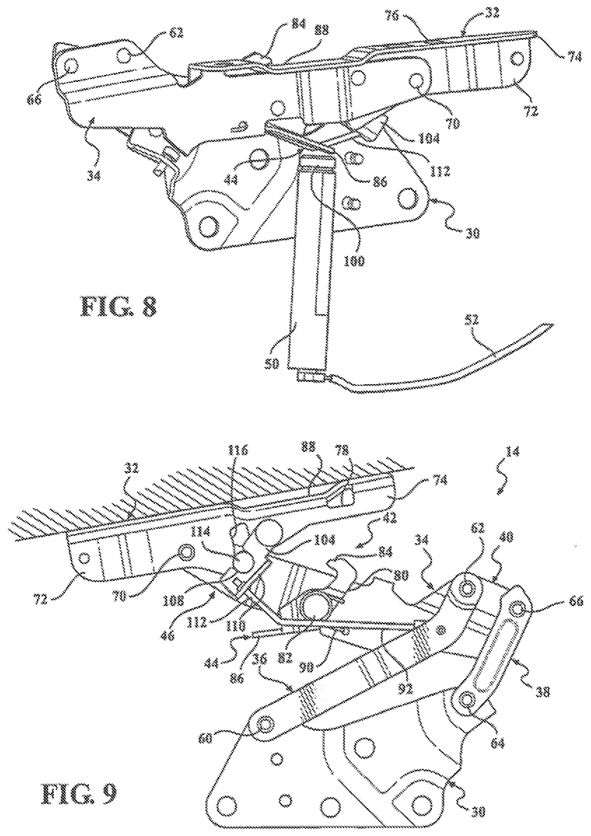

FIGS. 6-8 illustrate active hinge 14 in its non-deployed condition with primary latch 42 in an engaged or latched mode for releaseably coupling hood bracket 32 and deploy bracket 34 for common pivotal movement (via linkage mechanism 40) relative to body bracket 30 to provide normal movement of hood 12 between its latched and open positions. Primary latch 44 also includes a primary release lever 92 interconnected between actuation flange 86 and deploy bracket 34. As best seen in FIG. 8, a moveable actuator element 100 of actuator 50 is positioned in close proximity to actuation flange 86 of primary latch plate 80 and is operable, upon actuation of actuator 50, to forcibly move primary latch plate 80 from its engaged position to a released position, thereby shifting primary latch 44 into a released mode and permitting independent movement of hood bracket 32 to deploy bracket 34.

Secondary latch 46 includes a secondary latch plate 104 pivotably mounted to wall segment 72 of hood bracket 32 via a secondary latch pivot pin 106. Secondary latch plate 104 includes a capture slot 108. A secondary latch biasing spring 110 normally biases secondary latch plate 104 in a latching direction (clockwise in FIGS. 6 and 7). A secondary release lever 112 is also shown interconnecting secondary latch plate 104 to deploy bracket 34. As is also shown, an upstop pin 114 is fixed to deploy bracket 34 and is seated in a lost-motion slot 116 formed in wall segment 72 of hood bracket 32. With primary latch 44 in its latched mode, upstop pin 114 engages an end portion of lost-motion slot 116 to properly orient hood bracket 32 relative to deploy bracket 34 when active hinge 14 is in its non-deployed condition. As shown, in this position, the hood bracket 32 may be disposed generally in alignment with the deploy bracket 34, i.e., not pivoted relative to the deploy bracket 34. Note that in this condition, capture slot 108 of secondary latch plate 104 is displaced from engagement with upstop pin 114 so as to define the released mode of secondary latch 46.

Referring now to FIG. 9, hood assembly 10 is shown in its deployed position with active hinge 14 operating in its deployed condition. Specifically, actuator 50 has engaged actuation flange 86 of primary latch plate 80 and caused pivotal movement thereof in a releasing direction, in opposition to the biasing of primary latch spring 90, so as to disengage capture flange 84 from latch surface 88, thereby shifting primary latch 44 in its released mode. Upon release of primary latch 44, pivot linkage 40 permits relative movement between deploy bracket 34 and hood bracket 32 until upstop pin 114 is located within capture slot 108 of secondary latch plate 104, thereby shifting secondary latch 46 into its engaged or latched mode. More specifically, the hood bracket 32 may pivot relative to the deploy bracket 34 in a first direction until upstop pin 114 is located within capture slot 108.

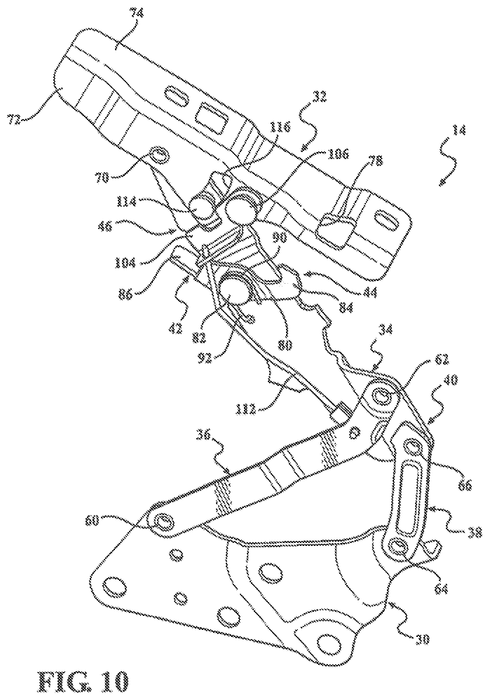

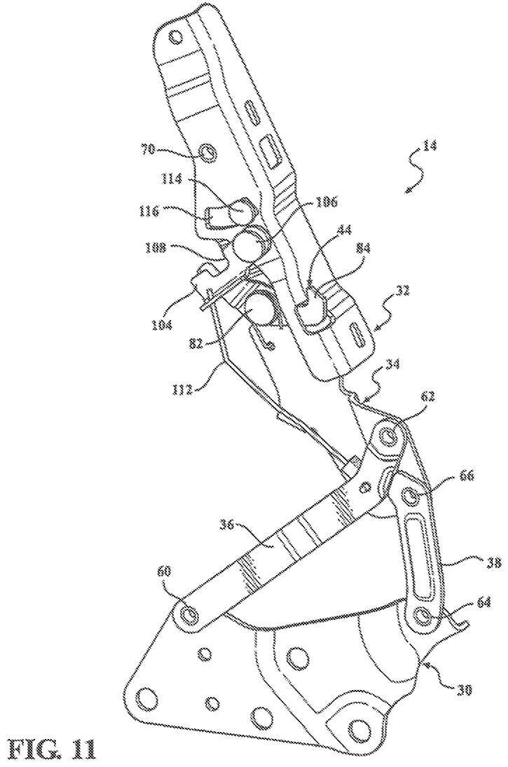

FIG. 10 illustrates active hinge 14 in its deployed condition after hood 12 has been unlatched and pivoted upwardly toward its intermediate open position of FIG. 3 at the start of the reset process. As seen, such rotation of hood 12 causes concurrent movement of hood bracket 32 relative to deploy bracket 34 which causes secondary release lever 112 to hold secondary latch plate 104 such that upstop pin 114 is released from capture slot 108, thereby shifting secondary latch 46 into its released mode while primary latch 44 is maintained in its released mode. FIG. 11 illustrates continued upward pivotal movement of hood 12 to its fully open or reset position similar to FIG. 4. As seen, this continued rotation causes hood bracket 32 to pivot relative to deploy bracket 34 until primary latch 44 is returned to its latched mode, thereby resetting active hinge 14 in its non-deployed condition. More specifically, the hood bracket 32 may pivot in a second direction, opposite the first direction, until the primary latch 44 is returned to its latched mode. As such, hood 12 can subsequently be returned to its latched and lowered position with hood assembly 10 is in its normal-closed position shown in FIGS. 1 and 5. As recognized, FIGS. 1 through 5 provide a sequential series of illustrations depicting the non-deployment, deployment and subsequent resetting of active hinge 14 utilizing latch mechanism 42 to provide two distinct mechanical connections between hood bracket 32 and deploy bracket 34.

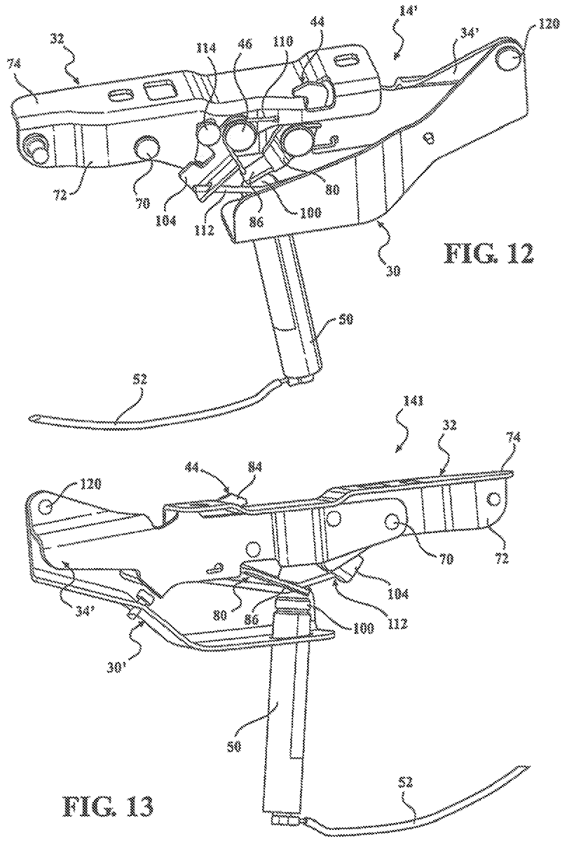

FIGS. 12 and 13 illustrate a second example embodiment of an active hinge 14′ which is generally similar to active hinge 14 except that four-bar pivot linkage mechanism 40 has been replaced with a single pivot connection 120, as an example of a fastener 15c, between body bracket 30′ and deploy bracket 34′. However, the integration of latching mechanism 42 between deploy bracket 34′ and hood bracket 32 remains the same in both structure and function to provide both primary latch 44 and secondary latch 46 therebetween.

In accordance with the present disclosure, an active hinge is disclosed that employs a latching mechanism to maintain the hinge in its non-deployed and deployed conditions. A first latch is used to releaseably maintain the hinge in its non-deployed state while a second latch is used to releaseably maintain the hinge in its non-deployed state. A reset function is provided by which both latches are initially released and then the first latch is subsequently re-engaged to re-establish the non-deployed condition allowing closure of the hood to its normal use position following a pedestrian collision event.

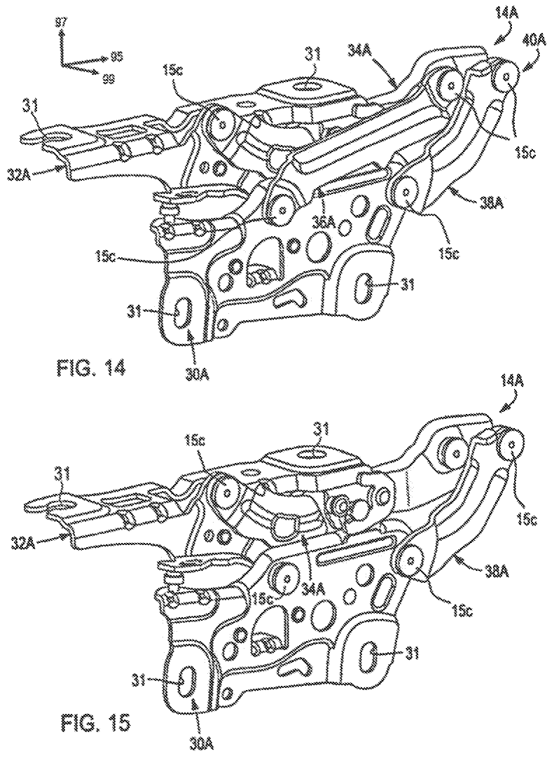

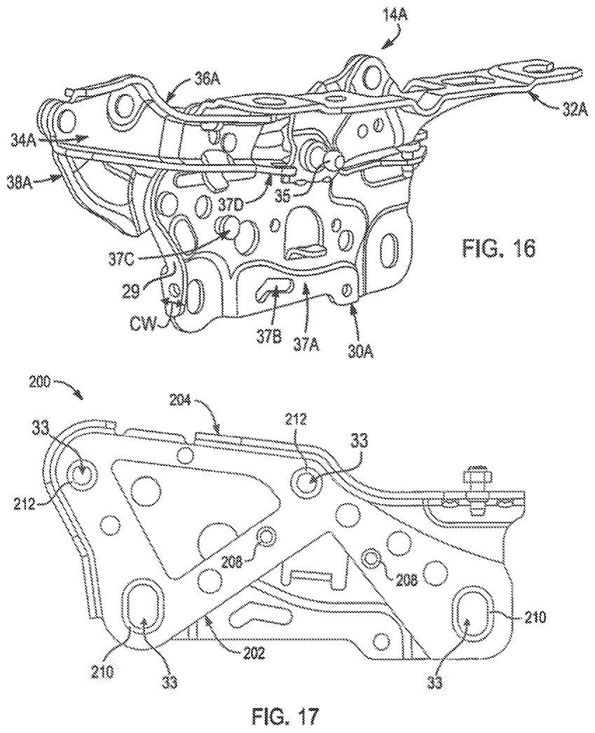

Referring to FIGS. 14-16 another alternative hinge 14A having hinge components including a body bracket (“hinge strap-body”) 30A, a hood bracket (“hinge strap-hood”) 32A, a deploy bracket (“hinge top part”) 34A, where the hood bracket 32A and the deploy bracket 34A are connected together via links, such as for example by a first long link (“link lever—long”) 36A, and a second short link (“lever lever-short”) 38A is illustrated. Body bracket 30A is configured to be secured to the body 11 of the vehicle 9, such as via fasteners 15b received and passing through body mounting bores 31, also referred to as apertures, and the fasteners 15b functioning to secure the body bracket 30A to the vehicle body 11, and for example compress the body bracket 30A against the vehicle body 11 to prevent play and movement there between. Likewise, hood bracket 32A is configured to be secured to hood 12 via fasteners 15a passing through hood mounting bores 31. Likewise, the first long link 36A and the second short link 38A are illustratively coupled to body bracket 30A and to hood bracket 32A via fasteners 15c, which may be for example a pin type fastener, a nut and bolt type fastener, or a rivet type fastener, as examples and without limitation. As previously disclosed, a series of pivot pins or bearings, referred to as generally as fasteners, are used to pivotally mount long link 38A and short link 38A to both body bracket 30A and deploy bracket 34A to allow rotation there between, as well as to pivotally mount deploy bracket 34A to hood bracket 32A and establish a four-bar pivot linkage 40A. To allow for such relative rotation by fasteners 15c, as compared to the higher compressive action of fasteners 15b, 15a, fasteners 15c may not be brought into compressive engagement between long link 38A and short link 38A to both body bracket 30A and deploy bracket 34A and hoot bracket 32A. FIG. 16 best shows a connection point 35 to connect hood bracket 32A to the gas compression spring, as well as various actuator 50A points including support area 37A, mounting area 37B, suspension area 37C, and a propel/contact area 37D.

The components shown in FIGS. 14-16 are all illustrative of conventional stamped metal components providing in-plane (for example along the X and Y axis represented by arrows 95 and 97) rigidity and strength to support the function of active hinge 14A, however, providing minimal material and structure extending in the cross-wise (CW) direction (for example along the Z axis represented by arrow 99) to provide out of plane stiffness. Such illustrative conventional stamped metal component may be provided with bent edges and ledges, illustratively shown as reference number 29, formed during the stamping process, however, such structures 29 may not provide sufficient stiffening material at locations experiencing higher loading as will be described in more details herein below, and may be difficult to form at those desired locations by stamping. Furthermore, the thickness of the structures 29 extending cross-wise is limited to the thickness of the metal blank to be stamped, further limiting the material providing stiffness to the stamped hinge. While such metal components are the norm, the advanced efforts disclosed herein to reduce cost and weight while maintaining and enhancing the structural integrity has resulted now in development of “composite” or “hybrid” hinges and hinge components, which are detailed hereinafter. The terms “composite” or “hybrid” are used herein for example to refer to a composite structure using distinct materials to form the hinge, and/or a composite structure using distinct structural features to form the hinge, such as structural reinforcement features as will be described in more details herein below.

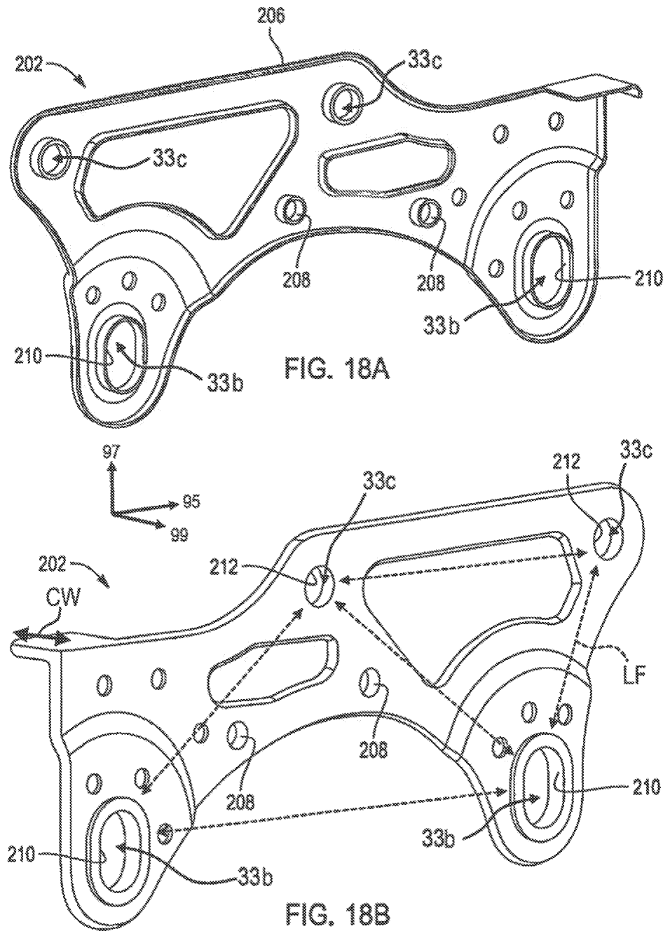

FIGS. 17-19B illustrate a hinge component, and in particular a composite body bracket or hinge strap body component 200 having a planar core exemplified as metal core panel 202, and a plastic body portion 204 over-molded onto metal core panel 202. Metal core panel 202 is formed with a continuous edge 206, threaded mounting holes 208 for mounting components such as actuator 50 thereto for example, a pair of tubular support collars 210 bounding at least one fastener receiving aperture, embodied as bushing holes 212 for receiving rotatable fasteners, such as fasteners 15c. Metal core panel 202 may be formed from stamping for forming a planar structure providing strength in directions within its plane, and for example strength along high loading flux paths exemplified by phantom lines indicated using reference numerals LF interconnecting the mounting bores 33 and/or the bushing holes 212. Metal core panel 202 includes an in plane extent significantly greater than its cross-width extent which in this form provides an in plane strength greater than an out of plane strength which may result in bending of the metal core 202 when subjected to a side cross-wise directional loading. Plastic body portion 204 connected to metal core panel 202 is provided to extend in an out of plane direction, for example in the Z-axis direction 99, from metal core 202 to provide structure for increasing stiffness to component 200.

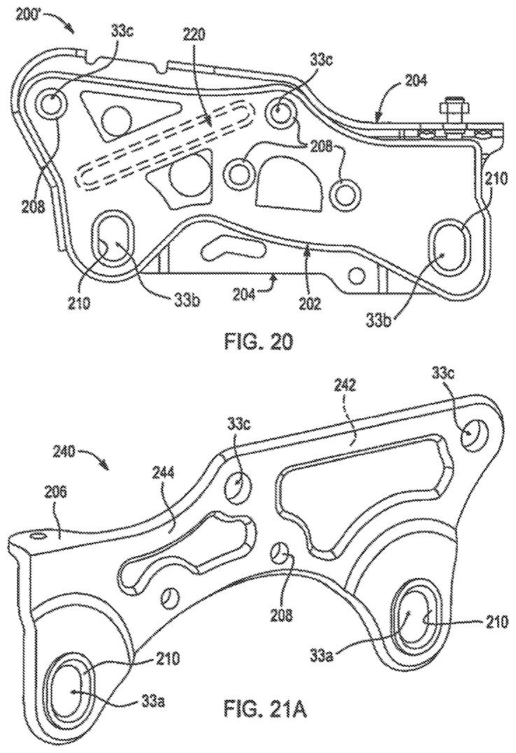

FIG. 20 illustrates another exemplary version of a hinge component, and in particular a modified version of composite hinge strap body component 200, noted as reference numeral 200′, having metal core panel 202, plastic overmolded part 204 secured or connected to metal core panel 202 for example by overmolding, and optionally one or more fiber-reinforced structural inserts 220 encapsulated within plastic part 204. Plastic body portion 204 provides a cross-width CW extending structure to the otherwise planar metal core panel 202 adding stiffness to the composite body bracket or hinge strap body component 200 to resist any cross-wise loading which may otherwise cause bending or deformation of a stamped metal core 202. It should be appreciated that since the apertures 33 are formed in the metal core panel 202, a robust connection to the vehicle 9 may be provided. Loadings LF transferred between the apertures 33 in the plane of the metal core 202 may be supported by the higher strength planar metal core 202. Furthermore, the metal core panel 202 facilitates the transfer of forces between fasteners 15b, 15c and therefore between the vehicle body 11 and the hinge links 36, 38, 36A, 36B and structurally reinforces the body bracket or hinge strap body component 200 along the force load paths LF between the mounting bores 33. As a result, other portions of the body bracket or hinge strap body component 200 not or less subjected to such in plane force flux loadings may be provided with a different lighter material such as plastic or other polymer and/or provided with a different structure, for reducing the weight of the body bracket or hinge strap body component 200, and/or for providing cross-width stiffness to the body bracket or hinge strap body component 200.

FIGS. 21A and 21B are front and rear isometric views of another composite body bracket or hinge strap body component 240 having a planar core, such as a thermoformed fiber composite core panel 242 overmolded with a fiber reinforced plastic 244. Preferred, but non-limiting, materials for composite core panel 242 may include Tepex® dynalite 201-C200(x)/50% Carbon (3 mm thick) and Durethan® BKV 30 H2.0 (PA6-GF30) and materials for and plastic layer 244 may include, but are not limited to, Tepex® materials and other bond laminates. The general configuration of component 240 is nearly identical to component 200, but no longer utilizes a metal inner core panel.

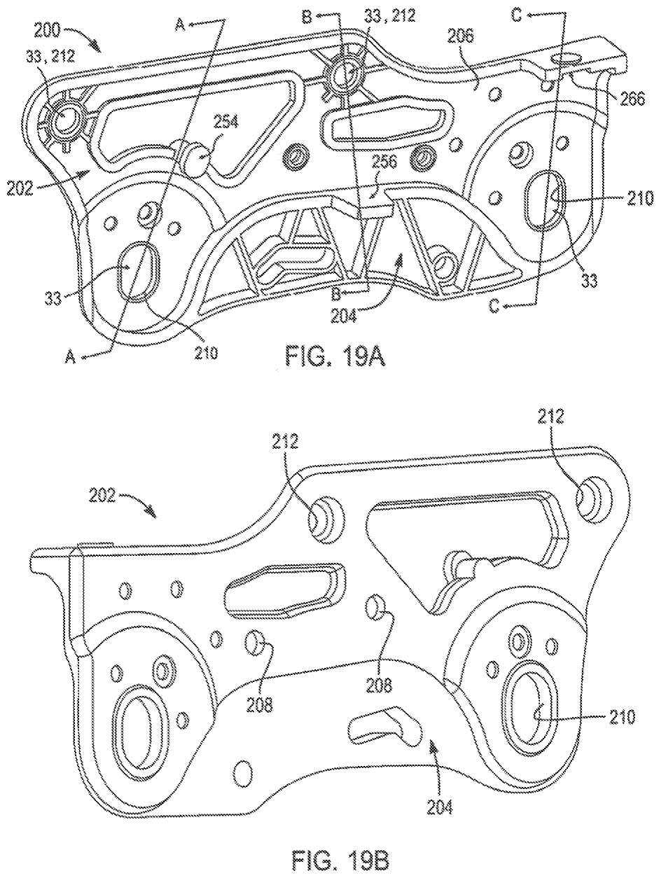

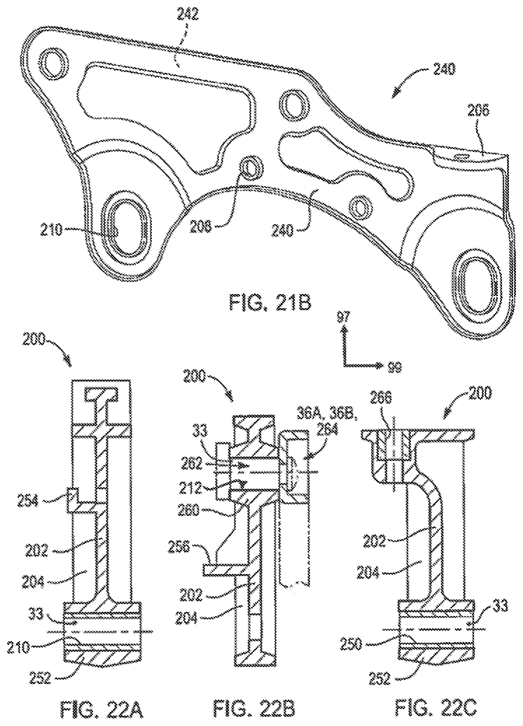

FIGS. 22A-22C illustrate partial sectional views of component 200 to better show certain integrated features. For example, FIG. 22A is a cross-sectional view taken along the line A-A of FIG. 19A illustrating an overmolded steel sleeve 210 located in a tubular boss section 252, and mounting fasteners such as hook 254 formed from the metal core 202 during stamping. Likewise, FIG. 22B is a cross-sectional view taken along the line B-B illustrating an integrated bushing hole 212 with a fastener 15c, 262, received therein, such as a bearing bolt or rivet, extending there through for pivotally attaching a link such as lever 36A, 36B, 264. Finally, FIG. 22C is a cross-sectional view taken along the line C-C illustrating an integrated screw socket 266 formed in the metal core 202 for receiving a screw or nut for mounting a component, such as a height adjustable bumper, therewith to the component 200.

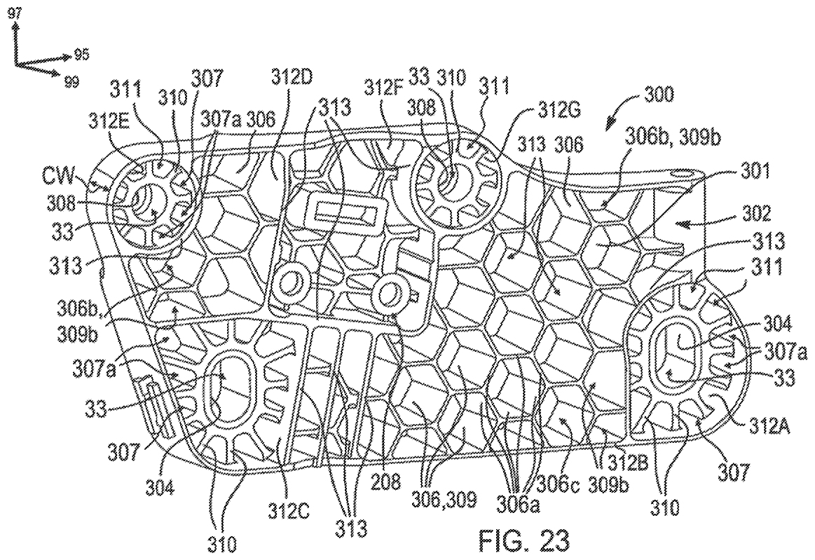

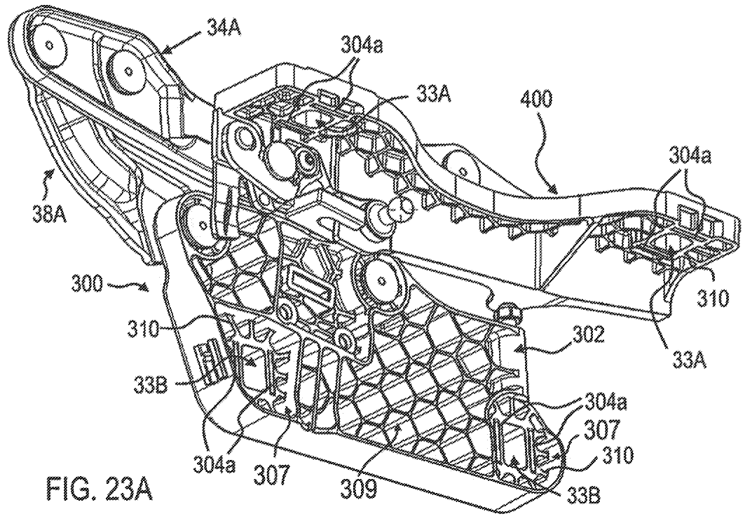

FIG. 23 illustrates yet another example of a composite or hybrid hinge component, illustrated as a body bracket or composite hinge strap body component 300 having a body segment 302 formed from a plastic material and illustratively at least a pair of support sleeves 304, such as metal support sleeves 304 for example. Body segment 302 is an example of a plastic body portion, however now provided without a planar metal core.

Plastic body segment 302 is illustratively formed using an injection molding process and may include a light weight reinforced structure exemplified as an array of cells 306, illustratively shown as a series of nested cells 306b formed from a series of interconnected ribs 306a arranged in a geometric pattern, such as in a hexagon or honeycomb shape, to define a plurality of cavities 306c. Cells 306 illustratively extend in a cross-width or cross-wise (CW) direction, extending in an out of plane direction from a planar structure 301 on a first side 315 (facing into the page of FIG. 23) of component 300 thereof to form a face presenting the array of cells 306, for example on an opposite second side 317 (facing out of the page of FIG. 23) which may also be formed during the injection molding process to therefore form a monolithic structure including the planar structure 301 and the array structure 306. Array of cells 306, which may include one or more subarrays, for example array of cells 306 may include subarrays 307, 309 are illustratively connected to and extend away from the planar structure 301. The face presenting the array of cells 306 may include another planar structure (not shown) overlying and connected to at least a portion of the array of cells 306. The cells 306b may be provided as other types of geometric shapes formed from the plurality of ribs 306a, such as triangular, pentagonal, circular, oval, square, rectangular, and the like, for forming a reinforcing structure or web-like structure, as illustrated in FIG. 23. It is recognized that the process of injection molding polymer material, such as plastic, may be performed using an additive manufacturing process, and may employ materials such as molten plastics and metal.

The array of cells 306 may be formed as a composite structure having two or more sub-structures, such as the subarray of cells, whereby each sub-structure has a different structure from one another. Such a difference between structures may include as examples a difference in shape of the structure, such as differently shaped cells, and/or a difference in density of the structure for example one structure being formed using more plastic material than the other as an example, and/or a difference in the specific strength and specific stiffness, and/or the width of the ribs forming the cells may be wider than the ribs forming the cells of the other structure. For example, a first structure, such as a first subarray of cells 307 having one or more first subcells 307a may be provided surrounding apertures 33. The subcells 307a may be formed to define the holes or bush bores 308 surrounded by an integrally formed tubular sleeve to provide a bushing structure for supporting a pivotal fastener 15c, and illustratively includes at least one, and may include a plurality of radially radiating web-like reinforcement ribs 310 defining cavities 311 therebetween. The one or more second subarray 309 illustratively includes a plurality of nested honeycomb cells 306b, 309b. Cells 306 provide a lightweight structure for strengthening and stiffening the hinge component such as the hinge strap body component 300 having a body segment 302, and may be formed at desired locations extending from the planar structure 301 and with a desired strength and volume of material.

Still referring to FIG. 23 in addition to FIG. 23A, component 300 may include support inserts 304 illustratively to surround an aperture 33 for receiving a fastener, such as fastener 15a, 15b. For example, support inserts 304 may be a support sleeve 304 formed from metal which is press-fitted or overmolded into body segment 302 and extending cross-width CW between the first side 315 of the component 300 and the opposite second side 317 of the component 300 and which may define the aperture 33 and is immediately adjacent the aperture 33 for example. Other types of connections between the support sleeves 304 and the body segment 302 are possible. Alternatively, support sleeves 304 may be formed from a plastic material along with the body segment 302 forming an integral and monolithic component, and having for example a tubular structure. Support inserts 304 may be provided as a tubular metal sleeves as shown in FIG. 23, or as a planar plate insert, such as a pair of opposed metal plate inserts 304a as shown in FIG. 23A and illustratively extend cross-width CW between opposite first side 315 and second side 317 of the body segment 302 for example. Such planar plate inserts may form part of the described tubular structure when the support insert 304 is formed from a plastic material and positioned adjacent the aperture 33 as illustrated in FIG. 23A. Inserts 304, 304a may be provided to abut on their opposite ends an adjacent assembled component, such as the vehicle body 11, hood 12, or other hinge component such as links 36A, 38B. Inserts 304 may be provided for supporting the higher compressive loading due to higher torqued fasteners 15b, 15a, as compared to pivotal fasteners 15c which must not be so compressed in a manner that would bring together the hinge components preventing relative rotation between parts. Inserts 304 may also be provided as a integrally molded structure formed as a thicker tube having a wall thickness greater than the wall thickness as compared to the thickness of the ribs 310 as embodied as bush bores 308 for supporting fasteners with lower compressive loading such as fasteners 15c which require the fastener to allow pivotal movement between the interconnecting hinge components, for example between the body bracket 30A or hood bracket 32A and the links 36A, 38A.

Still referring to FIG. 32, body segment 302 may include an interface structure shown as a cross-wise CW extending reinforcing rails 313 provided to further enhance structural integrity and provide an interface between differently shaped reinforcement ribs 310 or cells 306 of adjacent subarrays and defining compartments of arrays 312A-312G . Providing such an interface structure may facilitate different array structures having different densities and patterns for example to be interconnected with one another. Reinforcing rails 313 may also be provided as a support surface for components, such as actuator 50 secured to body segment 302 for example by threaded connection with threaded mounting holes 208.

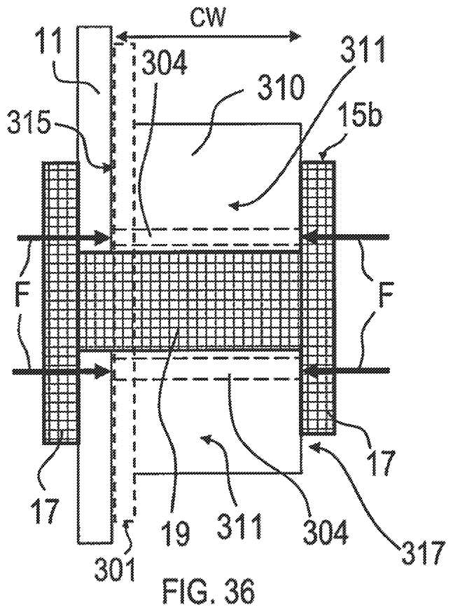

Now with reference to FIG. 36, in addition to FIG. 23, sleeves 304 may function to provide a high strength support structure to resist the localized compressive force F applied by fasteners 15a, 15b, 15c in a cross-wise CW direction on body segment 302, and in particular on the first structure illustrated as a first subarray 307 surrounding the aperture 33b, to avoid such compressive loading from being transferred to and deforming or crushing the surrounding reinforcing structure, such as by deforming the radially radiating web-like reinforcement ribs 310 of first subarray 307 as illustrated in FIG. 36. Furthermore, reducing or eliminating the continuous compressive loading on the surrounding plastic first structure 307 due to the torqued fastener 15b, 15c, also prevents fatigue damage to the plastic material which may reduce the strength of the surrounding plastic subcells 307A over time and generate clearances between the fastener 15b, 15a, and the plastic body segment 302 causing noise, rattle and play between the body bracket or composite hinge strap body component 300 and the vehicle body 11. As shown in FIG. 36, fasteners 15b, 15a may be a rivet or a screw or a nut and bolt type fastener and may illustratively include opposite heads 17 interconnected by a fastener shaft 19 for maintaining the opposed heads 17 together and compressing the hinge component 300 against the vehicle body 11 or hood 12, such as compressing the body segment 302 against the vehicle body 11 to secure the hinge strap body component 300 to the vehicle 9. Since the compressive loading forces imparted by the fasteners 15b, 15a on body bracket or composite hinge strap body component 300 are transferred through sleeves 304 and away from the surrounding body segment 302, such as the surrounding first subarray subcells 307a structure for example, the strength of such surrounding first structure may be reduced and rather optimized for withstanding any lateral non-continuous in plane loading imparted by the fastener 15b, 15a on the first subarray 307 and/or to resist any out of plane loading on the first subarray 307, and the corresponding weight of the body segment 302 may also be reduced.

Therefore, web-like reinforcement ribs 310 forming the array of cells 306, 307. 309 may be formed for providing localized strength and stiffness resisting the different loading and direction of loading subjected to the different portions of hinge component which may be caused by movement of the hood 12 during opening and closing, during a firing of the active pedestrian protection system, or during a crash event as examples. Therefore, a hinge component is provided having a first structure with a first strength for surrounding an aperture for receiving a fastener, and a second structure having a second lower strength for surrounding the first structure. For example the first structure may be the first subarray of cells 307 and the second structure may be the second subarray of cells 309. The higher localized loading subjected to the first structure surrounding the aperture 33 for receiving fastener 15 imparted by either a continuous compressive loading caused by the fastener, or by a dynamic cross-wise or lateral in plane loading caused by movement of the hood 10 relative to the body 11 may be supported by the first structure, while the distributed loading caused by load fluxes LF between the apertures 33, or between first structures may be supported by the second structure. Since the flux of forces LF between apertures 33 may be distributed over the larger second structure, and for example over a larger network of cells 306b, 309b formed by reinforcement ribs 310 as compared to the localized compressive force F caused by fasteners 15, the second structure may be provided having a lower strength, such as a lower strength to weight ratio or specific strength for example by providing a lower density of material forming the second structure for example.

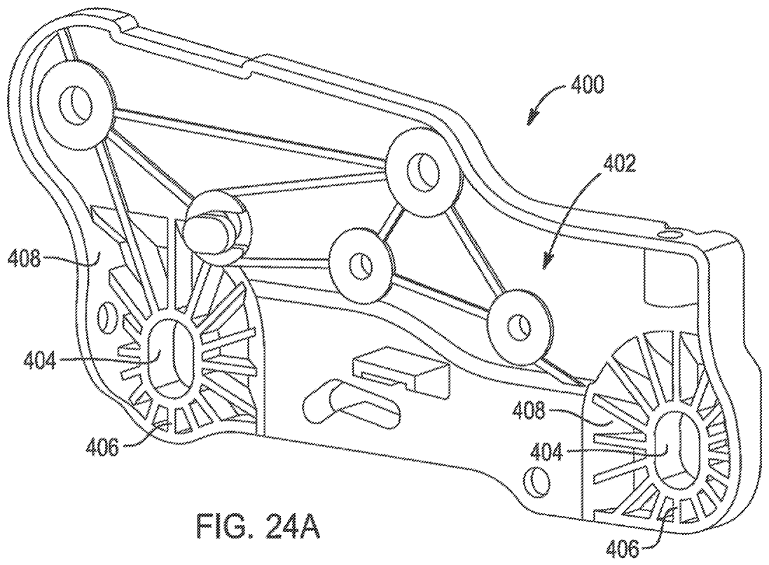

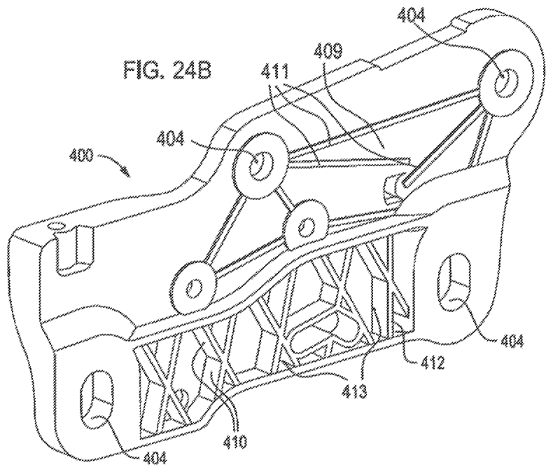

FIGS. 24A and 24B illustrate a modified version of a composite body bracket or hinge strap body component 400 having a body segment 402 formed without steel sleeves 304 (FIG. 23), but rather with integrated bush bores 404 defining apertures 33b surrounded by radially radiating reinforcement ribs 406 forming a first structure, such as a first subarray of cells. Body segment 402 is illustratively formed from three composite structures. For example a second structure is illustratively shown as an array of cells provided by ribs 410 defining cavities 413 in a control component 412 of body section 402. Such a second structure is not honeycombed, but rather formed as nested triangular cells extending cross-width providing weight reduction and stiffness to the body segment 402. The reinforcing structure provided by ribs 410 illustratively interconnects bush bores 404 bounded or surrounded by ribs 406 for providing a reinforced pathway for force transfer between the bush bores 404. Body segment 402 further includes a third structure 409 formed as a solid planar structure having cross-wise extending ribs 411 interconnecting holes or bush bores 408 for receiving pivotal fasteners 15c. Preferred, but non-limiting, materials may include, but are not limited to, PA66-CF30: Akromid A3 ICF 30 (Akro Plastic), PA66-LGF50: ULtramid AW3WG10LF (BASF®), PEEK—CF30: Victrex Peek ZA30 (VICTREX®).

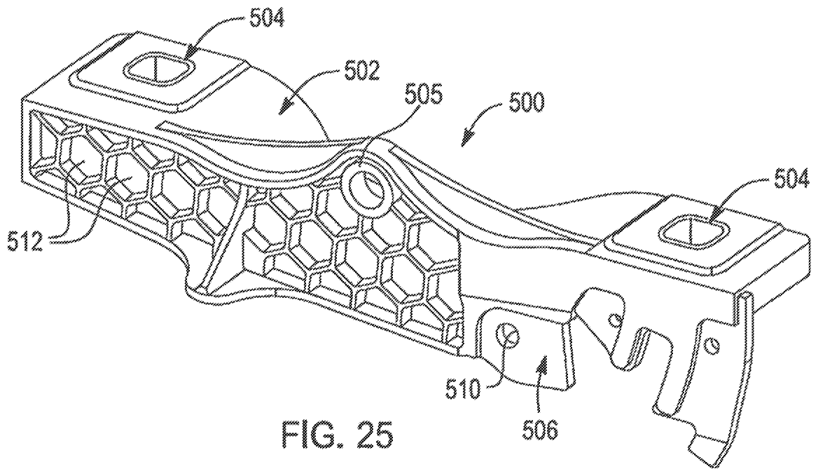

In addition to construction of composite body bracket/hinge strap body components, the present disclosure is also directed to composite hood bracket/hinge strap hood components for use with the active hinges as an example. In this regard, FIG. 25 illustrates a composite hinge strap hood component 500 having an injection molded plastic body segment 502, a pair of tubular inserts 504 such as for example a pair of a metal tubular inserts, overmolded into body segment 502, a reinforced plastic tubular bushing 505 molded as part of body segment 502, and a metal mounting plate 506 also overmolded into body segment 502. Metal plate 506 has a mounting bore 510 for pivotally supporting the deploy bracket, such as deploy bracket 34A. Body segment 502 is shown to include honeycombed cells 512 to provide required strength and rigidity.

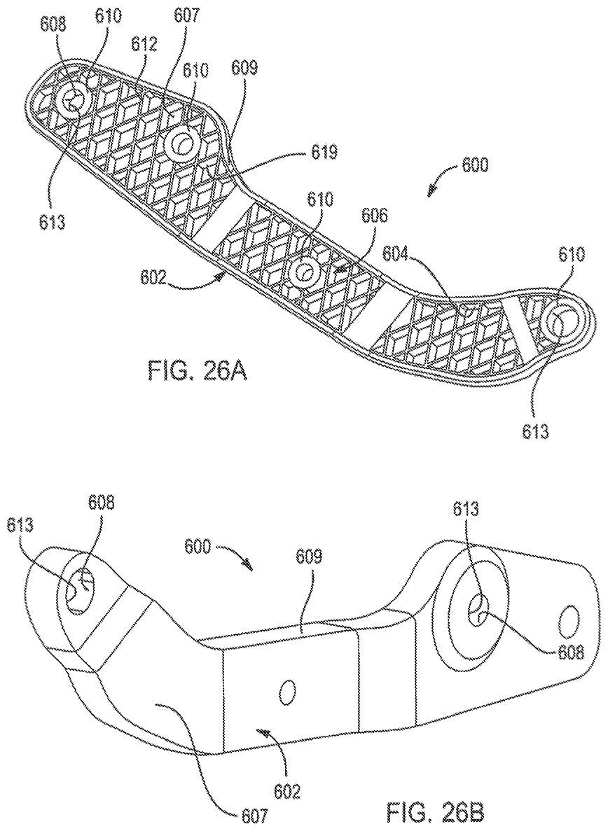

Further, the present disclosure is directed to composite or “hybrid” lever arms or lever links for use in hinges, such as active or passive hinges. In this regard, FIGS. 26A and 26B illustrate a lever link 600 having a metal housing 602 having a planar base 607 and a sidewall 609 extending transversely from the base 607 to define a U-shaped chamber 604, and a plastic body part 606 retained (i.e., snapped, molded, adhesive, etc.) within chamber 604. The base 607 of the metal housing 602 defines a pair of housing channels 613. The plastic body part 606 defines a pair of bearings 610 that are each positioned in alignment with one of the housing channels 613. The bearings 610 or bushings each define a bearing channel 608, or aperture, for receiving a fastener, such as fastener 15c for coupling the lever link 600 to a bracket. Pair of bearings 610 may be a pair of overmolded or press-fitted metal sleeve inserts, or be an integrally molded reinforced plastic sleeve to resist the pivotal loading from fasteners 15c. The plastic body part 606 is shown, in this non-limiting example, to include a series of hexagonal cavities formed by reinforcement ribs 612 interconnecting the sleeves 610.

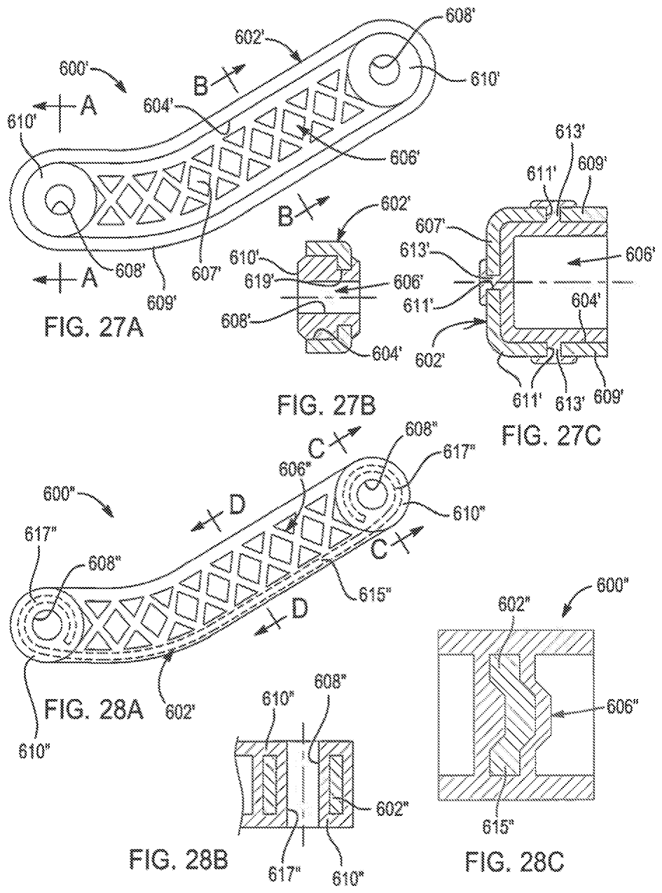

FIGS. 27A-27C provide views of an additional embodiment of a similar lever link 600′. Like the previous embodiment, the metal housing 602′ has a planar base 607′ and a sidewall 609′ extending transversely from the base 607′ to define a U-shaped chamber 604′. As shown in FIG. 27C, the sidewall 609′ defines a plurality of openings 611′. The plastic base 607′ includes a plurality of tabs 613′ received by, and coupled with the openings 611′ of the metal housing 602′ for securing the plastic body part 606′ to the metal housing 602′. The metal housing 602′ defines a pair of housing channels 619′ that each receive a bearing 610′ or bushing that is defined by the a solid tubular sleeve formed as part of the plastic body part 606′. The bearing 610′ defines a bearing channel 608′ or aperture for receiving a fastener for coupling the link 600′ with a bracket. Bearing 610′ is an example of a first structure surrounding an aperture 33 to resist the loading imparted by the fastener 15c, and is shown as a solid structure without cells which illustrates an example of a structure of greater density than a cell type structure, while plastic base 607′ is an example of a second structure interconnected with the first structure, and is shown as an array of cells having cross-wise extending ribs.

FIGS. 28A-28C illustrate an alternative version of lever link 600″ having a metal core plate 602″ encapsulated within a plastic outer body part 606″. The plastic outer body part 606″ defines a pair of spaced bearings 610″. The bearings 610″ or bushings each define a bearing channel 608″ or aperture for receiving a fastener for coupling the link 600″ with a bracket, and is an example of a first structure to resist the loading imparted by the fastener 15c. FIG. 28A illustrates that the metal core plate 602″ is configured like a leaf spring with a main section 615″ and two rolled end sections 617″ that wind about the bearings 610″. In accordance with such an illustrative examples, a hinge component is provided having a pair of first structures each surrounding an aperture for receiving a fastener, a second structure interconnecting the first structures, and a metal core interconnecting the apertures. Links 36A, 36B may be formed for example using the similar constructions of lever link 600, 600′, 600″. It is recognized that bearings 610, 610′, 610″ are illustrated as integrally formed with the plastic body part 606, 606′, 606″, but an insert, such as metal sleeve inserts described hereinabove may be provided to surround the aperture and/or form the bearing.

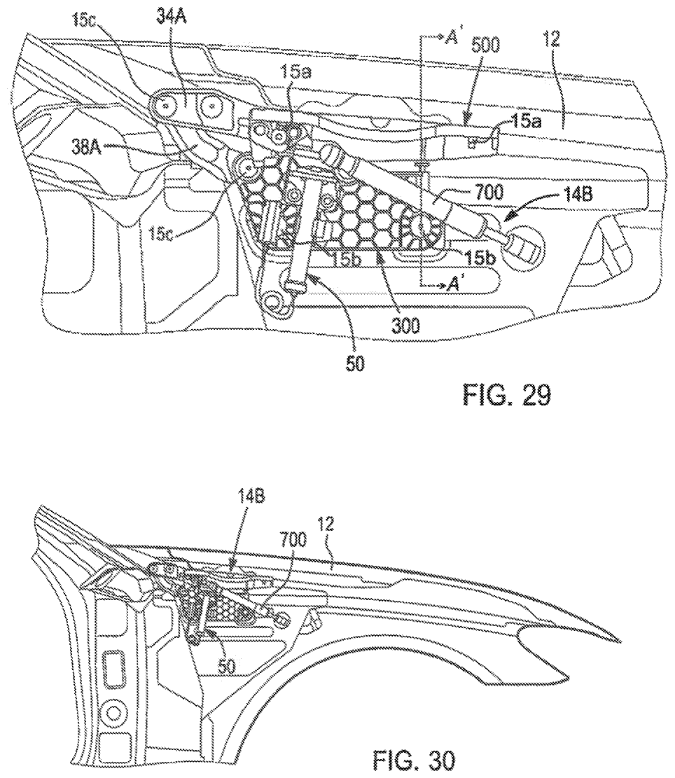

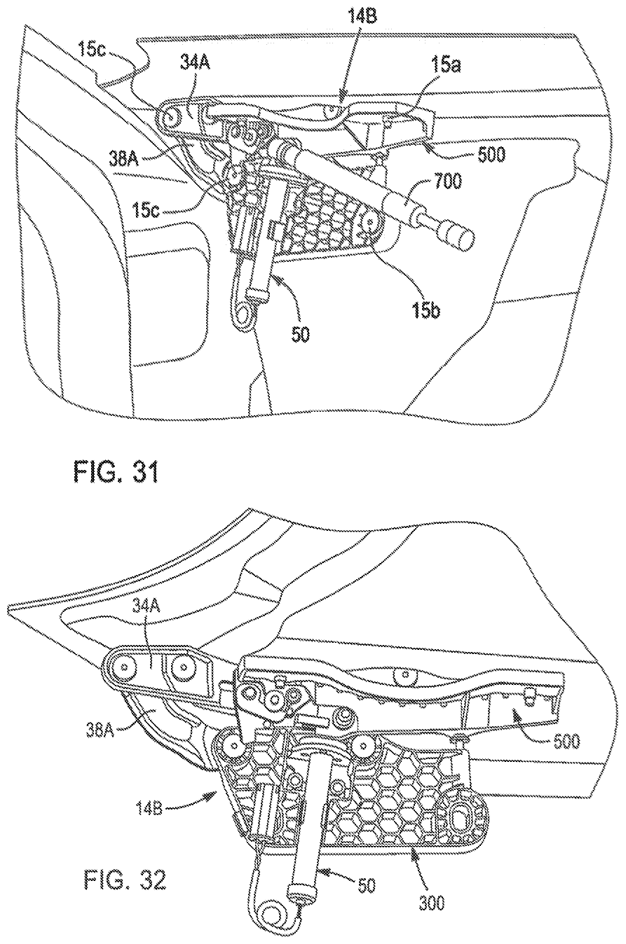

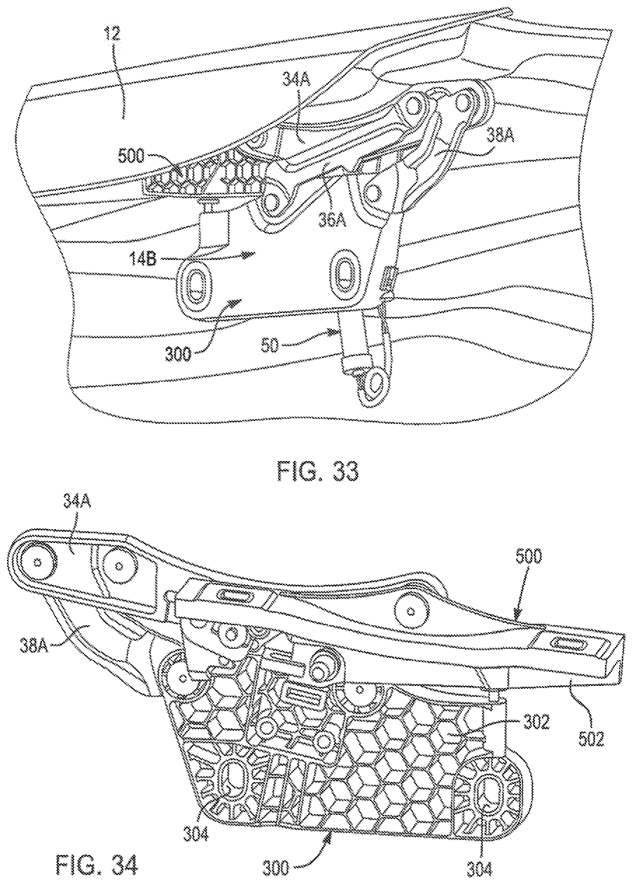

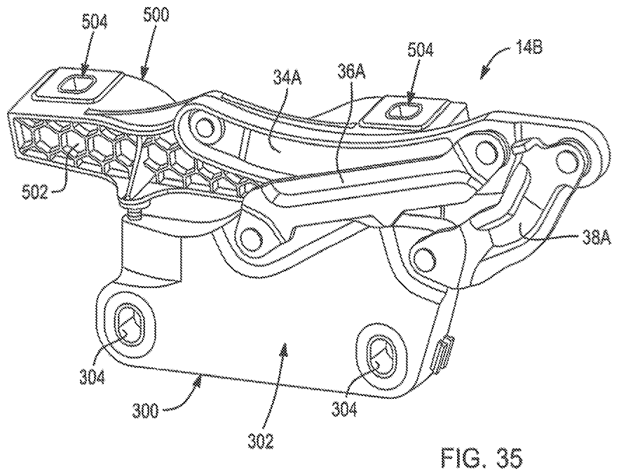

Referring to FIGS. 29-35, an active hinge 14B is shown equipped with one or more composite/hybrid hinge components of the types previously described in FIGS. 17-28 which will now be described. Active hinge 14B is installed between hood 12 and the body structure of the vehicle 9. Active hinge 14B generally includes composite body bracket 300 (FIG. 23) installed to the vehicle body 11 via fasteners 15b received within aperture 33b and compressively engaging the adjacent body bracket structure via the support sleeves 304, hybrid hood bracket 500 (FIG. 25) installed to the hood 12 via fasteners 15a received within aperture 33a and compressively engaging the adjacent hood bracket structure such as the support sleeves 504, a forged aluminum deploy bracket 34A, a metal long link 36A, and a metal short link 38A respectively coupled to the hood bracket 500 and the body bracket 300 via fasteners 15c as described herein above. FIGS. 29-31 illustrate a gas compression spring 700 connected between the vehicle body 11 and hood bracket 500 while actuator 50 is also shown in several views.

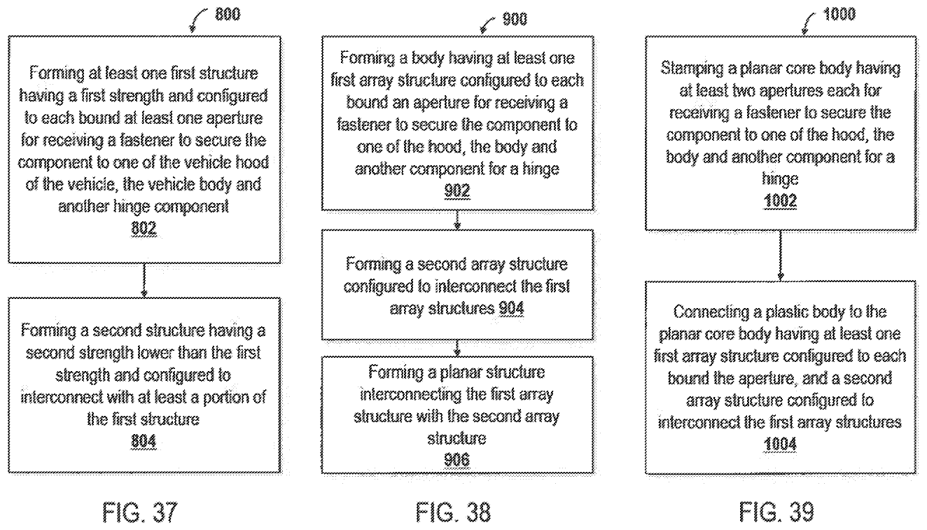

Now referring to FIG. 37, there is illustrated a flowchart of a method of manufacturing a component for a hinge 800, including the steps of forming, such as by molding, at least one first structure, such as a first array structure, having a first strength, such as a first specific strength and/or strength stiffness, and configured to each bound at least one aperture for receiving a fastener to secure the component to one of a vehicle hood, a vehicle body and another hinge component 802, and forming, such as by molding for example, a second structure, such as a second array structure, having a second strength lower than the first strength and configured to interconnect with at least a portion of the first structure 804. The first and the second structures may be formed simultaneously as part of an injection molding process by injecting molten elastomeric material such as plastic material into a mold using injection molding techniques or a printing technique such as additive manufacturing, in which case molten plastic or metal may be printed to form the structures described herein. The method may further include the step of forming a planar structure interconnecting the first structure and the second structure. The method may further include the step of forming the first array structure as the first structure and forming the second array structure as the second structure. The method may further include the step of forming the first array structure having a plurality of ribs radially extending away from the aperture. The method may further include the step of forming the second array structure having a plurality of nested cells, such as nested honeycomb cells. The method may further include the step of providing a metal insert surrounding the aperture.

Now referring to FIG. 38, there is provided in accordance with an illustrative embodiment a method of manufacturing a component for a hinge for coupling a hood to a body of a vehicle 900, including the steps of forming, such as for example by molding, a body having at least one first array structure configured to each bound an aperture for receiving a fastener to secure the component to one of the hood, the body and another component for a hinge 902, and forming, such as by molding, a second array structure configured to interconnect the first array structures 904, and forming, such as by molding, a planar structure interconnecting the first array structure with the second array structure 906.

Now referring to FIG. 39, there is provide in accordance with an illustrated embodiment a method of manufacturing a component for a hinge for coupling a hood to a body of a vehicle 1000, including the steps of stamping a planar core body having at least two apertures each for receiving a fastener to secure the component to one of the hood, the body and another component for a hinge 1002, and connecting, such as by overmolding for example, a plastic body to the planar core body having at least one first array structure configured to each bound the aperture for receiving a fastener to secure the component to one of the hood, the body and another component for a hinge, and a second array structure configured to interconnect the first array structures 1004. The first array structure and the second array structure may extend crosswise the component for providing stiffness to the hinge.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in that particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or later, or intervening element or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to described various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. The term “Plastic” is considered to be inclusive of any non-metallic material capable of being molded. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The foregoing description of the embodiments has been provided for purposes of illustration and description. It is not intended to be exhaustive or to limit the disclosure. Individual elements, assemblies/subassemblies, or features of a particular embodiment are generally not limited to that particular embodiment, but, where applicable, are interchangeable and can be used in a selected embodiment, even if not specifically shown or described. For example, the various hinge components described herein may be provided each with the teachings of the various embodiments, such as they may be provided as examples with one or more array structures, with metal reinforcing inserts or sleeves surrounding apertures, with metal or other planar cores, and generally hinge components provided with a planar structure with out of plane extending structures having varying densities along the planar structure for providing strength and stiffness at portions of the hinge component subjected to higher loading, such as about apertures for receiving fasteners, and weight reduction by not providing out of plane extending structural density for portions of the hinge component not subjected to or subjected to lessor loading forces. The same may also be varied in many ways. Such variations are not to be regarded as a departure from the disclosure, and all such modifications are intended to be included within the scope of the disclosure.

What is claimed is:

1. A hinge comprising:
a hood bracket for attachment to a vehicle hood; and
a body bracket for attachment to a vehicle body;
wherein at least one of the body bracket and hood bracket is a composite component having a plastic body portion.

2. The hinge of claim 1 further comprising:
a deploy bracket pivotably attached to said hood bracket and said body bracket, said hood bracket being pivotable relative to said deploy bracket between a non-deployed position and a deployed position; and
an actuator for moving said hood bracket to its deployed position.

3. The hinge of claim 2 wherein said deploy bracket is pivotably coupled to said body bracket via a pivot linkage mechanism having at least one composite link lever.

4. The hinge of claim 1 wherein at least one of said body bracket and said hood bracket includes a metal core panel and wherein said plastic body portion is secured to the metal core panel.

5. The hinge of claim 4 wherein said plastic body portion is overmolded onto said metal core panel and extends from said metal core panel with varying densities.

6. The hinge of claim 1 wherein at least one of said body bracket and said hood bracket includes at least one support insert made of metal adjacent an aperture formed in said at least one of said body bracket and said hood bracket for receiving a fastener.

7. The hinge of claim 6 wherein the plastic body portion is overmolded over said at least one support insert.

8. The hinge of claim 1 wherein at least one of said body bracket and said hood bracket is of a plastic material and includes a face presenting an array of cells for providing strength and stiffness to said plastic body portion.

9. The hinge of claim 8 wherein said array of cells includes a first subarray of cells provided to surround an aperture formed in one of said body bracket and said hood bracket for receiving a fastener.

10. The hinge of claim 9 wherein the array of cells further includes a second subarray of cells coupled with at least a portion of the said subarray of cells.

11. The hinge of claim 10 further including an interface structure interconnecting said first subarray of cells with said second subarray of cells.

12. The hinge of claim 10 wherein said first subarray of cells includes a plurality of reinforcement ribs radially extending away from said aperture, and said second subarray of cells includes a plurality of reinforcement ribs forming an array of nested cells.

13. The hinge of claim 10 including at least two first subarray of cells each surrounding one of at least two apertures formed in one of said body bracket and said hood bracket for receiving a fastener, wherein said second subarray of cells is in interconnection with the said subarray of cells.

14. The hinge of claim 13 wherein a specific strength of said first subarray of cells is greater than a specific strength of said second subarray of cells.

15. The hinge of claim 8, wherein at least one of said body bracket and hood bracket further includes a planar structure, said array of cells extending away from said planar structure.

16. The hinge of claim 9 where said first subarray of cells is connected to a metal support insert surrounding said aperture

17. The hinge of claim 16 wherein said first subarray of cells includes at least one reinforcement rib of a plastic material extending radially away from the aperture.

18. The hinge of claim 6 further comprising at least one tubular sleeve defining an integrated bush bore overmolded into said plastic body portion for receiving a fastener rotatable within said aperture.

19. The hinge of claim 1 further comprising an aperture formed in one of said body bracket and said hood bracket for receiving a fastener to secure said at least one of said body bracket and said hood bracket respectively to the vehicle body or the vehicle hood, and at least one metal support insert supported by the at least one of said body bracket and said hood bracket adjacent the aperture and extending cross-wise between a first side and a second side of said at least one of said body bracket and said hood bracket.

20. A component for a hinge for a motor vehicle, comprising:
a body portion having at least two apertures each for receiving a fastener, the body portion having a planar structure extending along a plane and an array structure coupled to said planar structure and extending in a direction away from said plane of said planar structure, wherein the density of said extending array structure is maximal about said apertures.
